(19) United States
(12) Patent Application Publication
(10) Pub. No.: US 2004/0144303 A1
(43) Pub. Date: Jul. 29, 2004

(54) Assembly for blade coating

(76) Inventor: Tore Eriksson, Klassbol (SE)

Correspondence Address: BURNS DOANE SWECKER & MATHIS L L P, POST OFFICE BOX 1404, ALEXANDRIA, VA, 22313-1404, US

(21) Appl. No.: 10/478,842

(22) PCT Filed: Jun. 13, 2002
(86) PCT No.: PCT/SE02/01150

(30) Foreign Application Priority Data
Jun. 15, 2001 (SE) 0102132-8

(51) Int. Cl. B05C 11/02; B05C 1/00

(52) U.S. Cl. 118/106; 118/200

(57) ABSTRACT

Assembly for blade coating of a travelling web, comprising a blade (6) and a blade holder (7, 10) for said blade. Said assembly is provided with a foil (9) extending along the full length of the blade (6) and attached to the blade along a line or section extending along the blade at position between a free edge of the blade and an opposite edge thereof attached in said blade holder, said foil having a width so as to cover the blade holder on a side thereof facing said web.

The present invention relates to an assembly for blade coating of a travelling web, said assembly comprising a blade and a blade holder for said blade.

The term coating indicates that a travelling web, for example a paper web, is subject to application of a coating formulation in liquid form. Frequent techniques of applying coating agent in a controlled manner are based on the use of so called blade coating technology. When using this technology the coating agent is first supplied to the web in excess. The final metering of the coating agent then takes place by use of coating blade, the blades simultaneously metering and evening the coating layer. The coating blade operates according to a so called trailing principle, i.e. the angle between plain of the blade and the web is less than 90° and usually lies within the range 15-45°. In view of the friction between the blade and web the blade is subjected to a force acting in the direction of the travel of the web the blade must be securely attached in a holder.

In traditional blade coating the blade is secured between a fixed and a movable jaw, the engaging surface is thereof being parallel. In this manner the blade will be firmly attached and cannot move between the jaw surfaces. The pressure of the free edge of the blade against the paper web is provided by the springing action of the blade when engaging the web.

In another blade arrangement has disclosed for example U.S. Pat. No. 5,529,806 the blade is held by the blade holder so that it can perform a rocking motion around the line of engagement. In view of this arrangement the blade need not be bent for providing the pressure of the free edge of the blade against the web. The engagement force is in this case provided by an exterior force applied near the free edge of the blade.

In view of the fact that the blade holder allows a rocking motion of the blade it is provided with a recess or groove above the point of the rocking motion. However, this recess or groove necessary for the function of the blade is related to two drawbacks:

One drawback is constituted by the fact that the recess generates turbulence in the excess of coating liquid which is adopted by the blade and flows back on the plain surface of the blade the blade holder for recirculation thereof. This turbulence can cause problems with a mixture of air and splashes.

A second problem related to this recess is that coating agent which contains up to 70% of dry solids, dries on the hot surfaces. Particularly in applying the techniques of rocking motion this is a problem since dried coating agent can “fill up” the recess above the rocking point which means that the ability of the blade to a rock in said point will be reduced.

The tendency of the coating agent to dry and attach to hot surfaces is a problem generally encountered in the coating technology. A usual way of solving this problem is to cool the surfaces which come into contact with the coating agent. For practical reasons this is not possible to perform on the surfaces which provide attachment of the blade. This means that considerable cleaning operation will be required at every exchange of blade and this is relevant to all types of blade holders but is particularly pronounced in the blade holder described above provided with a recess above the point of rocking. Since loss of production occurs during the period of exchange of blade considerable savings can be obtained if the period for cleaning will be reduced.

Another problem in blade coating using springing or bent blade is that the blade will be subjected to a strong flexing tension and at the same time is subjected to corrosion attack by the coating liquid. This stress corrosion will be at a maximum where the jaws end, and in the worst case this can lead to breakage of blade along this line.

The main object of the present invention is to eliminate or reduce the need for cleaning in connection with the exchange of blade thereby reduced loss of production.

Another object to the invention is to reduce the splashing rising when the return flow of coating liquid from the blade comes into contact with the blade holder's jaws or enters the recess in the blade holder described earlier.

Yet another object of the invention is to reduce the problems with stress corrosion arising when using bent or springing blades.

For these and other objects which will be clear from the following disclosure the invention provides for an assembly for blade coating or travelling web, said assembly comprising a blade and a blade holder for said blade. The invention is characterized by a foil which extends along the full length of the blade and which is attached to the blade along a line or section extending along the blade at a position between the free edge of the blade and the opposite edge thereof attached in said blade holder. This foil has a width so as to cover the blade holder on the side thereof facing said web.

Said foil providing protection for the blade holder is suitably constituted by a thin flexible material, such as a polymeric material. The material is preferably an organic polymer, such as an elastomer, or a polyolefin, for example polyethylene or polypropylene.

Said foil has preferably a thickness within the range about 0.05 to about 1 millimetre, such as between about 0.1 and about 0.2 millimetre.

In order to secure the protected blade holder the foil has suitably a width from about 50 to 500 millimetres, such as from about 100 to about 200 millimetres. It goes without saying that said width is elected according to the size of the blade holder.

The invention will in the following be described with specific embodiments which, however, are not to be construed as restricting the scope of the invention. In the figures:

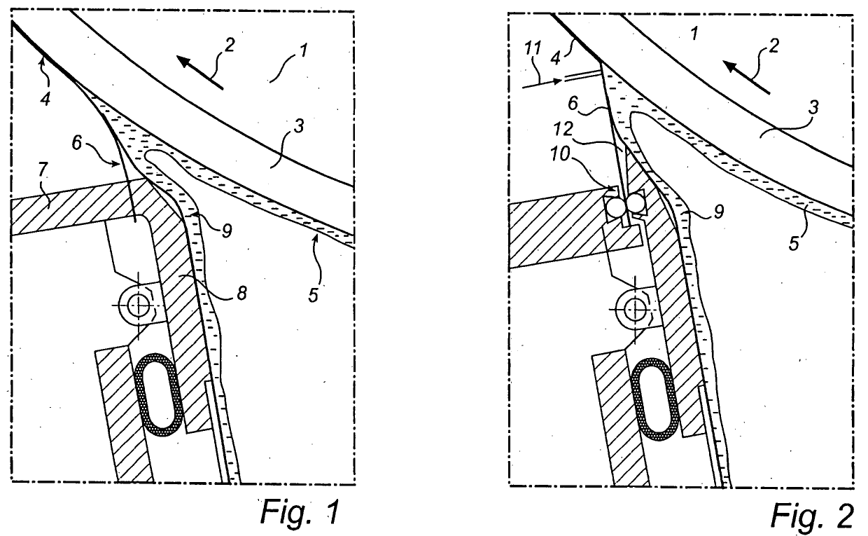

FIG. 1. shows a traditional blade holder with bent or springing blade and including the protecting foil according to the invention; and

FIG. 2. shows a blade holder according to U.S. Pat. No. 5,529,806 and a blade equipped with a foil in accordance with the invention.

FIG. 1 shows a traditional blade coating arrangement with a roller 1 moving in the direction shown with arrow 2. The mantel of the roller has a rubber coating 3. The travelling web 4 is moved forward by the friction against the surface of the role. The coating liquid 5 applied to the web upstream of the blade will be transported up to the coating blade 6 by the travelling web. The coating blade 6 which is firmly attached between a fixed jaw 7 and a movable jaw 8 then meters the final amount of coating liquid applied on to the web. The excess of coating liquid from the blade is carried on the surface of foil 9 attached to the blade and close back to a collecting tray.

It is clear from FIG. 1 that the foil prevents coating liquid from coming into contact with the blade attachment arrangement and in particular that the transition between the blade and the movable jaw will be continuous and even.

FIG. 2. shows a corresponding arrangement that where the blade is not bent but is held between holding means 10 allowing rocking motion of the blade. The force of engagement against the web at the free edge of the blade is in this case not due to springing action of the blade but is provided by an exterior force represented by the arrow 11 applied near the free edge of the blade. FIG. 2 shows how the pocket 12 above the point of rocking will be protected and evened out by the foil 9.

The invention is, of course, not limited to the embodiments shown above since alternative examples of embodiments are conceivable. Thus, the attachment of the docter blade can be carried out in many ways meeting with the requirements of a firm attachment or a movability of the blade.

1. Assembly for blade coating of a travelling web, comprising a blade (6) and a blade holder (7; 10) for said blade, characterized by a foil (9) extending along the full length of the blade (6) and attached to the blade along a line or section extending along the blade at a position between a free edge of the blade and an opposite edge thereof attached in said blade holder, said foil having a width so as to cover the blade holder on a side thereof facing said web.

2. Assembly according to claim 1, wherein said foil (9) is constituted by a polymer.

3. Assembly according to claim 2, wherein said polymer is an organic polymer.

4. Assembly according to claim 2 or 3, wherein said polymer is a polyolefin, such as polyethylene or polypropylene.

5. Assembly according to any preceding claim, wherein said foil (9) has a thickness within the range about 0.05 to about 1 millimetre.

6. Assembly according to claim 5, wherein said thickness is within the range about 6.1 to 0.2 millimetre.

7. Assembly according to any preceding claim, wherein said foil (9) has a width of from about 50 to about 500 millimetres.

8. Assembly according to claim 7, wherein said width is from about 100 to about 200 millimetres.
